(19) United States
(12) Patent Application Publication
(10) Pub. No.: US 2007/0066710 A1
(43) Pub. Date: Mar. 22, 2007

(54) Method for electrical insulation and insulated electrical conductor

(76) Inventors: Edward Norman Peters, Lenox, MA (US); Zhiqing Lin, Loudonville, NY (US); Hua Guo, Selkirk, NY (US)

Correspondence Address: CANTOR COLBURN, LLP, 55 GRIFFIN ROAD SOUTH, BLOOMFIELD, CT, 06002, US

(21) Appl. No.: 11/231,585

(22) Filed: Sep. 21, 2005

(51) Int. Cl. C09D 11/00

(52) U.S. Cl. 523/160

(57) ABSTRACT

An electrically conductive material may be electrically insulated with a curable composition that includes a curable compound, such as an unsaturated polyester resin, and a functionalized poly(arylene ether) resin. After curing, the composition exhibits increased flexural strength, increased impact strength, and improved tensile properties relative to currently employed insulation materials.

### BACKGROUND OF THE INVENTION

Current coil winding secondary insulation systems in motors, generators, and transformers are typically based on epoxy or unsaturated polyester resin systems. Current resin systems exhibit many desirable properties, including excellent electrical properties, high thermal endurance, and rapid cure rates. However, there is a desire for resin systems exhibiting reduced brittleness and higher mechanical strength in order to reduce insulation failure rates.

### BRIEF DESCRIPTION OF THE INVENTION

Insulated electrically conductive materials exhibiting reduced insulation brittleness and higher insulation mechanical strength are obtained by a method comprising applying to an electrically conductive material a curable composition comprising a functionalized poly(arylene ether); and a curable compound selected from olefinically unsaturated monomers, unsaturated polyester resins, epoxy resins, polyester/epoxy copolymers, unsaturated esterimide resins, curable silicones, and combinations thereof.

Other embodiments, including an insulated electrical conductor, are described in detail below.

### DETAILED DESCRIPTION OF THE INVENTION

One embodiment is a method comprising applying to an electrically conductive material a curable composition comprising a functionalized poly(arylene ether); and a curable compound selected from olefinically unsaturated monomers, unsaturated polyester resins, epoxy resins, polyester/epoxy copolymers, unsaturated esterimide resins, curable silicones, and combinations thereof.

The electrically conductive material may be any electrically conductive material suitable for use in wound coils for motors, generators, stators, transformers, and other coils for electrical devices. Suitable electrically conductive materials include, for example, copper wire, aluminum wire, lead wire, and wires of alloys comprising one or more of the foregoing metals. A coil is a continuous length of wire comprising an electrically conductive material that is wound into a series of concentric rings. The cross section of the coil may be cylindrical, rectangular, hollow, solid, or other variable shapes.

The curable composition may be applied to the surface of the electrically conductive material using any suitable techniques known in the art. Such varnish application techniques include, for example, dip and bake, dip and spin, vacuum/pressure impregnation, roll through, trickle application, and total encapsulation. These processes and others are described in, for example, Daniel R. Sassano, IEEE Electrical Insulation Magazine, November/December 1992, volume 8, number 6, pages 25-32; Mark Winkeler, Electrical Insulation Conference and Electrical Manufacturing & Coil Winding Conference, 1999, Proceedings, 26-28 Oct. 1999, pages 143-148; D. R. Speer, Jr., W. J. Saijeant, J. Zirnheld, H. Gill, and K. Burke, Electrical Insulation Conference and Electrical Manufacturing & Coil Winding Conference, 2001, Proceedings, 16-18 Oct. 2001, pages 467-472.

The curable composition comprises a functionalized poly(arylene ether). The functionalized poly(arylene ether) may be a capped poly(arylene ether), a particular type of dicapped poly(arylene ether), a ring-functionalized poly(arylene ether), or a poly(arylene ether) resin comprising at least one terminal functional group selected from carboxylic acid, glycidyl ether, vinyl ether, and anhydride.

In one embodiment, the functionalized poly(arylene ether) comprises a capped poly(arylene ether) having the formula
Q(J-K)_{y}
wherein Q is the residuum of a monohydric, dihydric, or polyhydric phenol; y is 1 to 100, more specifically 1, 2, 3, 4, 5, or 6; J has the formula 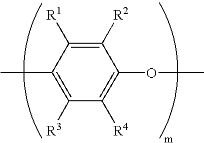
wherein R¹ and R³ are each independently selected from the group consisting of hydrogen, halogen, primary or secondary C₁-C₁₂ alkyl, C₂-C₁₂ alkenyl, C2-C₁₂ alkynyl, C₁-C₁₂ aminoalkyl, C₁-C₁₂ hydroxyalkyl, phenyl, C₁-C₁₂ haloalkyl, C₁-C₁₂ hydrocarbyloxy, and C₂-C₁₂ halohydrocarbyloxy wherein at least two carbon atoms separate the halogen and oxygen atoms; R² and R⁴ are each independently selected from the group consisting of halogen, primary or secondary C₁-C₁₂ alkyl, C₂-C₁₂ alkenyl, C2-C₁₂ alkynyl, C₁-C₁₂ aminoalkyl, C₁-C₁₂ hydroxyalkyl, phenyl, C₁-C₁₂ haloalkyl, C₁-C₁₂ hydrocarbyloxy, and C₂-C₁₂ halohydrocarbyloxy wherein at least two carbon atoms separate the halogen and oxygen atoms; m is 1 to about 200; and K is a capping group selected from the group consisting of 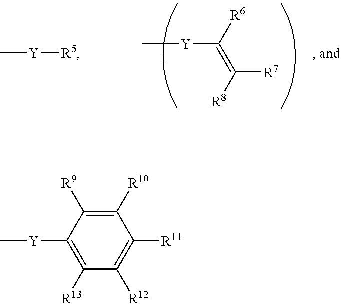
wherein R⁵ is C₁-C₁₂ hydrocarbyl optionally substituted with one or two carboxylic acid groups, R⁶-R⁸ are each independently hydrogen, C₁-C₁₈ hydrocarbyl optionally substituted with one or two carboxylic acid groups, C₂-C₁₈ hydrocarbyloxycarbonyl, nitrile, formyl, carboxylic acid, imidate, and thiocarboxylic acid; R⁹-R¹³ are each independently selected from the group consisting of hydrogen, halogen, C₁-C₁₂ alkyl, hydroxy, carboxylic acid, and amino; and wherein Y is a divalent group selected from the group consisting of 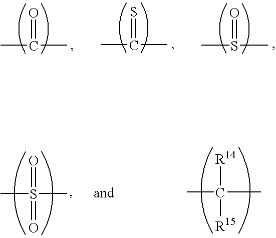
wherein R¹⁴ and R¹⁵ are each independently selected from the group consisting of hydrogen and C₁-C₁₂ alkyl. As used herein, “hydrocarbyl” refers to a residue that contains only carbon and hydrogen. The residue may be aliphatic or aromatic, straight-chain, cyclic, branched, saturated or unsaturated. The hydrocarbyl residue, when so stated however, may contain heteroatoms over and above the carbon and hydrogen members of the substituent residue. Thus, when specifically noted as containing such heteroatoms, the hydrocarbyl residue may also contain carbonyl groups (—C(O)—), ether groups (—O—), amino groups (—NH₂), hydroxyl groups (—OH), thiol groups (—SH), thioether groups (—S—), or the like, or it may contain heteroatoms within the backbone of the hydrocarbyl residue. As used herein, the term “haloalkyl” includes alkyl groups substituted with one or more halogen atoms, including partially and fully halogenated alkyl groups.

In one embodiment, Q is the residuum of a phenol, including polyfunctional phenols, and includes radicals of the structure 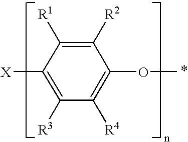
wherein R¹ and R³ are each independently hydrogen, halogen, primary or secondary C₁-C₁₂ alkyl, C₁-C₁₂ alkenyl, C₁-C₁₂ alkynyl, C₁-C₁₂ aminoalkyl, C₁-C₁₂ hydroxyalkyl, C₆-C₁₂ aryl (including phenyl), C₁-C₁₂ haloalkyl, C₁-C₁₂ aminoalkyl, C₁-C₁₂ hydrocarbonoxy, C₁-C₁₂ halohydrocarbonoxy wherein at least two carbon atoms separate the halogen and oxygen atoms, or the like; R² and R⁴ are each independently halogen, primary or secondary C₁-C₁₂ alkyl, C₁-C₁₂ alkenyl, C₁-C₁₂ alkynyl, C₁-C₁₂ aminoalkyl, C₁-C₁₂ hydroxyalkyl, C₆-C₁₂ aryl (including phenyl), C₁-C₁₂ haloalkyl, C₁-C₁₂ aminoalkyl, C₁-C₁₂ hydrocarbonoxy, C₁-C₁₂ halohydrocarbonoxy wherein at least two carbon atoms separate the halogen and oxygen atoms, or the like; X may be hydrogen, C₁-C₁₈ hydrocarbyl, or C₁-C₁₈ hydrocarbyl containing a substituent such as carboxylic acid, aldehyde, alcohol, amino radicals, or the like; X also may be sulfur, sulfonyl, sulfuryl, oxygen, C₁-C₁₂ alkylidene, or other such bridging group having a valence of 2 or greater to result in various bis- or higher polyphenols; y and n are each independently 1 to about 100, preferably 1 to 3, and more preferably about 1 to 2; in a preferred embodiment, y=n. Q may be the residuum of a monohydric phenol. Q may also be the residuum of a diphenol, such as 2,2′,6,6′-tetramethyl-4,4′-diphenol. Q may also be the residuum of a bisphenol, such as 2,2-bis(4-hydroxyphenyl)propane (“bisphenol A” or “BPA”).

In one embodiment, the capped poly(arylene ether) is produced by capping a poly(arylene ether) consisting essentially of the polymerization product of at least one monohydric phenol having the structure 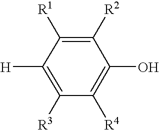
wherein R¹ and R³ are each independently hydrogen, halogen, primary or secondary C₁-C₁₂ alkyl, C₁-C₁₂ alkenyl, C₁-C₁₂ alkynyl, C₁-C₁₂ aminoalkyl, C₁-C₁₂ hydroxyalkyl, C₆-C₁₂ aryl (including phenyl), C₁-C₁₂ haloalkyl, C₁-C₁₂ aminoalkyl, C₁-C₁₂ hydrocarbonoxy, C₁-C₁₂ halohydrocarbonoxy wherein at least two carbon atoms separate the halogen and oxygen atoms, or the like; and R² and R⁴ are each independently halogen, primary or secondary C₁-C₁₂ alkyl, C₁-C₁₂ alkenyl, C₁-C₁₂ alkynyl, C₁-C₁₂ aminoalkyl, C₁-C₁₂ hydroxyalkyl, C₆-C₁₂ aryl (including phenyl), C₁-C₁₂ haloalkyl, C₁-C₁₂ aminoalkyl, C₁-C₁₂ hydrocarbonoxy, C₁-C₁₂ halohydrocarbonoxy wherein at least two carbon atoms separate the halogen and oxygen atoms, or the like. Suitable monohydric phenols include those described in U.S. Pat. No. 3,306,875 to Hay, and highly preferred monohydric phenols include 2,6-dimethylphenol and 2,3,6-trimethylphenol. The poly(arylene ether) may be a copolymer of at least two monohydric phenols, such as 2,6-dimethylphenol and 2,3,6-trimethylphenol.

In one embodiment, the capped poly(arylene ether) comprises at least one capping group having the structure 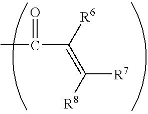
wherein R⁶-R⁸ are each independently hydrogen, C₁-C₁₈ hydrocarbyl, C₂-C₁₈ hydrocarbyloxycarbonyl, nitrile, formyl, carboxylate, imidate, thiocarboxylate, or the like; R⁹-R¹³ are each independently hydrogen, halogen, C₁-C₁₂ alkyl, hydroxy, amino, or the like. Highly preferred capping groups include acrylate (R⁶═R⁷═R⁸=hydrogen) and methacrylate (R⁶=methyl, R⁷═R⁸=hydrogen). It will be understood that the prefix “(meth)acryl-” means either “acryl-” or “methacryl-”.

In one embodiment, the capped poly(arylene ether) comprises a dicapped poly(arylene ether) having the structure 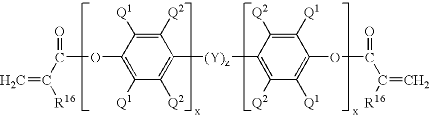
wherein each occurrence of Q² is independently selected from hydrogen, halogen, primary or secondary C₁-C₁₂ alkyl, C₂-C₁₂ alkenyl, C₃-C₁₂ alkenylalkyl, C₂-C₁₂ alkynyl, C₃-C₁₂ alkynylalkyl, C₁-C₁₂ aminoalkyl, C₁-C₁₂ hydroxyalkyl, phenyl, C₁-C₁₂ haloalkyl, C₁-C₁₂ hydrocarbyloxy, and C₂-C₁₂ halohydrocarbyloxy wherein at least two carbon atoms separate the halogen and oxygen atoms; and wherein each occurrence of Q¹ is independently selected from halogen, primary or secondary C₁-C₁₂ alkyl, C₂-C₁₂ alkenyl, C₃-C₁₂ alkenylalkyl, C₂-C₁₂ alkynyl, C₃-C₁₂ alkynylalkyl, C₁-C₁₂ aminoalkyl, C₁-C₁₂ hydroxyalkyl, phenyl, C₁-C₁₂ haloalkyl, C₁-C₁₂ hydrocarbyloxy, and C₂-C₁₂ halohydrocarbyloxy wherein at least two carbon atoms separate the halogen and oxygen atoms; each occurrence of R¹⁶ is independently hydrogen or methyl; each occurrence of x is independently 1 to about 100; z is 0 or 1; and Y has a structure selected from 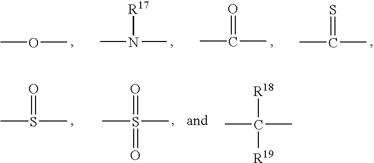
wherein each occurrence of R¹⁷, R¹⁸, and R¹⁹ is independently selected from hydrogen and C₁-C₁₂ hydrocarbyl.

There is no particular limitation on the method by which the capped poly(arylene ether) is prepared. The capped poly(arylene ether) may be formed by the reaction of an uncapped poly(arylene ether) with a capping agent. Capping agents include compounds known in the literature to react with phenolic groups. Such compounds include both monomers and polymers containing, for example, anhydride, acid chloride, epoxy, carbonate, ester, isocyanate, cyanate ester, or alkyl halide radicals. Capping agents are not limited to organic compounds as, for example, phosphorus and sulfur based capping agents also are included. Examples of capping agents include, for example, acetic anhydride, succinic anhydride, maleic anhydride, salicylic anhydride, polyesters comprising salicylate units, homopolyesters of salicylic acid, acrylic anhydride, methacrylic anhydride, glycidyl acrylate, glycidyl methacrylate, acetyl chloride, benzoyl chloride, diphenyl carbonates such as di(4-nitrophenyl)carbonate, acryloyl esters, methacryloyl esters, acetyl esters, phenylisocyanate, 3-isopropenyl-α,α-dimethylphenylisocyanate, cyanatobenzene, 2,2-bis(4-cyanatophenyl)propane), 3-(alpha-chloromethyl)styrene, 4-(alpha-chloromethyl)styrene, allyl bromide, and the like, carbonate and substituted derivatives thereof, and mixtures thereof. These and other methods of forming capped poly(arylene ether)s are described, for example, in U.S. Pat. No. 3,375,228 to Holoch et al.; U.S. Pat. No. 4,148,843 to Goossens; U.S. Pat. Nos. 4,562,243, 4,663,402, 4,665,137, and 5,091,480 to Percec et al.; U.S. Pat. Nos. 5,071,922, 5,079,268, 5,304,600, and 5,310,820 to Nelissen et al.; U.S. Pat. No. 5,338,796 to Vianello et al.; U.S. Pat. No. 6,627,704 B2 to Yeager et al.; and European Patent No. 261,574 B11 to Peters et al.

A capping catalyst may be employed in the reaction of an uncapped poly(arylene ether) with an anhydride. Examples of such compounds include those known to the art that are capable of catalyzing condensation of phenols with the capping agents described above. Useful materials are basic compounds including, for example, basic compound hydroxide salts such as sodium hydroxide, potassium hydroxide, tetraalkylammonium hydroxides, and the like; tertiary alkylamines such as tributyl amine, triethylamine, dimethylbenzylamine, dimethylbutylamine and the like; tertiary mixed alkyl-arylamines and substituted derivatives thereof such as N,N-dimethylaniline; heterocyclic amines such as imidazoles, pyridines, and substituted derivatives thereof such as 2-methylimidazole, 2-vinylimidazole, 4-(dimethylamino)pyridine, 4-(1-pyrrolino)pyridine, 4-(1-piperidino)pyridine, 2-vinylpyridine, 3-vinylpyridine, 4-vinylpyridine, and the like. Also useful are organometallic salts such as, for example, tin and zinc salts known to catalyze the condensation of, for example, isocyanates or cyanate esters with phenols.

In another embodiment, the functionalized poly(arylene ether) comprises a ring-functionalized poly(arylene ether) comprising repeating structural units of the formula 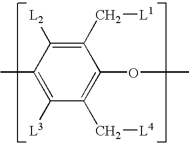
wherein each L¹-L⁴ is independently hydrogen, a C₁-C₁₂ alkyl group, an alkenyl group, or an alkynyl group; wherein the alkenyl group is represented by 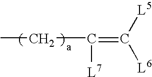
wherein L⁵-L⁷ are independently hydrogen or methyl, and a is 0, 1, 2, 3, or 4; wherein the alkynyl group is represented by 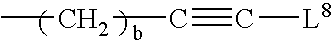
wherein L⁸ is hydrogen, methyl, or ethyl, and b is 0, 1, 2, 3, or 4; and wherein about 0.02 mole percent to about 25 mole percent of the total L¹-L⁴ substituents in the ring-functionalized poly(arylene ether) are alkenyl and/or alkynyl groups. Within this range, it may be preferred to have at least about 0.1 mole percent, more preferably at least about 0.5 mole percent, alkenyl and/or alkynyl groups. Also within this range, it may be preferred to have up to about 15 mole percent, more preferably up to about 10 mole percent, alkenyl and/or alkynyl groups. The ring-functionalized poly(arylene ether) of this embodiment may be prepared according to known methods. For example, an unfunctionalized poly(arylene ether) such as poly(2,6-dimethyl-1,4-phenylene ether) may be metallized with a reagent such as n-butyl lithium and subsequently reacted with an alkenyl halide such as allyl bromide and/or an alkynyl halide such as propargyl bromide. This and other methods for preparation of ring-functionalized poly(arylene ether) resins are described, for example, in U.S. Pat. No. 4,923,932 to Katayose et al.

In another embodiment, the ring-functionalized poly(arylene ether) is the product of the melt reaction of a poly(arylene ether) and an α,β-unsaturated carbonyl compound or a β-hydroxy carbonyl compound. Examples of α,β-unsaturated carbonyl compounds include, for example, maleic anhydride, citriconic anhydride, and the like. Examples of β-hydroxy carbonyl compounds include, for example, citric acid, and the like. Such functionalization is typically carried out by melt mixing the poly(arylene ether) with the desired carbonyl compound at a temperature of about 190 to about 290° C.

In one embodiment, the functionalized poly(arylene ether) resin comprises at least one terminal functional group selected from carboxylic acid, glycidyl ether, vinyl ether, and anhydride. These particular functionalized poly(arylene ether) resins are particularly useful in combination with epoxy resins. A method for preparing a poly(arylene ether) resin substituted with terminal carboxylic acid groups is provided in the working examples, below. Other suitable methods include those described in, for example, European Patent No. 261,574 B1 to Peters et al. Glycidyl ether-functionalized poly(arylene ether) resins and methods for their preparation are described, for example, in U.S. Pat. No. 6,794,481 to Amagai et al. and U.S. Pat. No. 6,835,785 to Ishii et al., and U.S. Patent Application Publication No. 2004/0265595 A1 to Tokiwa. Vinyl ether-functionalized poly(arylene ether) resins and methods for there preparation are described, for example, in U.S. Statutory Invention Registration No. H521 to Fan. Anhydride-functionalized poly(arylene ether) resins and methods for their preparation are described, for example, in European Patent No. 261,574 B1 to Peters et al., and U.S. Patent Application Publication No. 2004/0258852 A1 to Ohno et al.

In one embodiment, the poly(arylene ether) resin is substantially free of particles having an equivalent spherical diameter greater than 100 micrometers. The poly(arylene ether) resin may also be free of particles having an equivalent spherical diameter greater than 80 micrometers, or greater than 60 micrometers. Methods of preparing such a poly(arylene ether) are known in the art and include, for example, sieving.

There is no particular limitation on the molecular weight or intrinsic viscosity of the functionalized poly(arylene ether). In one embodiment, the functionalized poly(arylene ether) resin has an intrinsic viscosity of about 0.03 to about 0.6 deciliter per gram measured at 25° C. in chloroform. In another embodiment, the functionalized poly(arylene ether) resin has an intrinsic viscosity of about 0.06 to about 0.3 deciliter per gram measured at 25° C. in chloroform. Generally, the intrinsic viscosity of a functionalized poly(arylene ether) will vary insignificantly from the intrinsic viscosity of the corresponding unfunctionalized poly(arylene ether). Specifically, the intrinsic viscosity of a functionalized poly(arylene ether) will generally be within 10% of that of the unfunctionalized poly(arylene ether). It is expressly contemplated to employ blends of at least two functionalized poly(arylene ether)s having different molecular weights and intrinsic viscosities. The composition may comprise a blend of at least two functionalized poly(arylene ethers). Such blends may be prepared from individually prepared and isolated functionalized poly(arylene ethers). Alternatively, such blends may be prepared by reacting a single poly(arylene ether) with at least two functionalizing agents. For example, a poly(arylene ether) may be reacted with two capping agents, or a poly(arylene ether) may be metallized and reacted with two unsaturated alkylating agents. In another alternative, a mixture of at least two poly(arylene ether) resins having different monomer compositions and/or molecular weights may be reacted with a single functionalizing agent.

The curable composition may comprise about 1 to about 50 weight percent of the functionalized poly(arylene ether), based on the total weight of the curable composition. Within this range, the functionalized poly(arylene ether) amount may be at least about 5 weight percent, or at least about 10 weight percent. Also within this range, the functionalized poly(arylene ether) amount may be up to about 40 weight percent, or up to about 30 weight percent.

The curable composition comprises a curable compound selected from olefinically unsaturated monomers, unsaturated polyester resins, epoxy resins, polyester/epoxy copolymers, unsaturated esterimide resins, curable silicones, and combinations thereof. Suitable olefinically unsaturated monomers include, for example, acryloyl monomers, alkenyl aromatic monomers, allylic monomers, vinyl ethers, maleimides, and the like, and mixtures thereof.

The olefinically unsaturated monomer may comprise an acryloyl monomer. In one embodiment, the acryloyl monomer comprises at least one acryloyl moiety having the structure 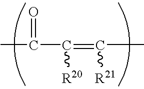
wherein R²⁰ and R²¹ are each independently selected from the group consisting of hydrogen and C₁-C₁₂ alkyl, and wherein R¹⁸ and R¹⁹ may be disposed either cis or trans about the carbon-carbon double bond.

In another embodiment, the acryloyl monomer comprises at least one acryloyl moiety having the structure 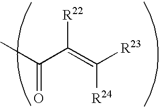
wherein R²²-R²⁴ are each independently selected from the group consisting of hydrogen, C₁-C₁₂ hydrocarbyl, C₂-C₁₈ hydrocarbyloxycarbonyl, nitrile, formyl, carboxylate, imidate, and thiocarboxylate.

In a preferred embodiment, the acryloyl monomer may include compounds having at least two acryloyl moieties per molecule, more specifically at least three acryloyl moieties per molecule. Illustrative examples include compounds produced by condensation of an acrylic or methacrylic acid with a di-epoxide, such as bisphenol-A diglycidyl ether, butanediol diglycidyl ether, or neopenylene glycol dimethacrylate. Specific examples include 1,4-butanediol diglycidylether di(meth)acrylate, bisphenol A diglycidylether dimethacrylate, and neopentylglycol diglycidylether di(meth)acrylate, and the like. Also included as acryloyl monomers are the condensation of reactive acrylate or methacrylate compounds with alcohols or amines to produce the resulting polyfunctional acrylates or polyfunctional acrylamides. Examples include N,N-bis(2-hydroxyethyl)(meth)acrylamide, methylenebis((meth)acrylamide), 1,6-hexamethylenebis((meth)acrylamide), diethylenetriamine tris((meth)acrylamide), bis(γ-((meth)acrylamide)propoxy) ethane, β-((meth)acrylamide) ethylacrylate, ethylene glycol di((meth)acrylate)), diethylene glycol di(meth)acrylate, tetraethylene glycol di(meth)acrylate, glycerol di(meth)acrylate, glycerol tri(meth)acrylate, 1,3-propylene glycol di(meth)acrylate, dipropyleneglycol di(meth)acrylate, 1,4-butanediol di(meth)acrylate, 1,2,4-butanetriol tri(meth)acrylate, 1,6-hexanedioldi(meth)acrylate, 1,4-cyclohexanediol di(meth)acrylate, 1,4-benzenediol di(meth)acrylate, pentaerythritol tetra(meth)acrylate, 1,5-pentanediol di(meth)acrylate, trimethylolpropane di(meth)acrylate, trimethylolpropane tri(meth)acrylate), 1,3,5-triacryloylhexahydro-1,3,5-triazine, 2,2-bis(4-(2-(meth)acryloxyethoxy)phenyl)propane, 2,2-bis(4-(2-(meth)acryloxyethoxy)-3,5-dibromophenyl)propane, 2,2-bis((4-(meth)acryloxy)phenyl)propane, 2,2-bis((4-(meth)acryloxy)-3,5-dibromophenyl)propane, and the like, and mixtures thereof.

In one embodiment, the acryloyl monomer is selected from trimethylolpropane tri(meth)acrylate, 1,6-hexanediol di(meth)acrylate, neopentyl glycol di(meth)acrylate, dipropylene glycol di(meth)acrylate, ethylene glycol di(meth)acrylate, propylene glycol di(meth)acrylate, cyclohexanedimethanol di(meth)acrylate, butanediol di(meth)acrylate, diethylene glycol di(meth)acrylate, triethylene glycol di(meth)acrylate, isobornyl(meth)acrylate, methyl(meth)acrylate, methacryloxypropyl trimethoxysilane, ethoxylated (2) bisphenol A di(meth)acrylate, and the like, and mixtures thereof.

Suitable further include acryloyl monomers further include the alkoxylated acryloyl monomers described in U.S. Pat. No. 6,812,276 to Yeager. Briefly, the alkoxylated acryloyl monomer may have the structure 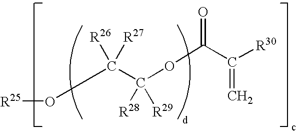
wherein R²⁵ is a C₁-C₂₅₀ organic group having a valence of c; each occurrence of R²⁶-R²⁹ is independently hydrogen, C₁-C₆ alkyl, or C₆-C₁₂ aryl; each occurrence of d is independently 0 to about 20 with the proviso that at least one occurrence of d is at least 1; each occurrence of R³⁰ is independently hydrogen or methyl; and c is 1 to about 10. In one embodiment, the alkoxylated acryloyl monomer comprises at least two (meth)acrylate groups. In another embodiment, the alkoxylated acryloyl monomer comprises at least three (meth)acrylate groups. Suitable alkoxylated acryloyl monomers include, for example, (ethoxylated)₁₋₂₀ nonylphenol (meth)acrylate, (propoxylated)₁₋₂₀ nonylphenol (meth)acrylate, (ethoxylated)₁₋₂₀ tetrahydrofurfuryl(meth)acrylate, (propoxylated)₁₋₂₀ tetrahydrofurfuryl (meth)acrylate, (ethoxylated)₁₋₂₀ hydroxyethyl(meth)acrylate, (propoxylated)₁₋₂₀ hydroxyethyl(meth)acrylate, (ethoxylated)₂₋₄₀ 1,6-hexanediol di(meth)acrylate, (propoxylated)₂₋₄₀ 1,6-hexanediol di(meth)acrylate, (ethoxylated)₂₋₄₀ 1,4-butanediol di(meth)acrylate, (propoxylated)₂₋₄₀ 1,4-butanediol di(meth)acrylate, (ethoxylated)₂₋₄₀ 1,3-butanediol di(meth)acrylate, (propoxylated)₂₋₄₀ 1,3-butanediol di(meth)acrylate, (ethoxylated)₂₋₄₀ ethylene glycol di(meth)acrylate, (propoxylated)₂₋₄₀ ethylene glycol di(meth)acrylate, (ethoxylated)₂₋₄₀ propylene glycol di(meth)acrylate, (propoxylated)₂₋₄₀ propylene glycol di(meth)acrylate, (ethoxylated)₂₋₄₀ 1,4-cyclohexanedimethanol di(meth)acrylate, (propoxylated)₂₋₄₀ 1,4-cyclohexanedimethanol di(meth)acrylate, (ethoxylated)₂₋₄₀ bisphenol-A di(meth)acrylate, (propoxylated)₂₋₄₀ bisphenol-A di(meth)acrylate, (ethoxylated)₃₋₆₀ glycerol tri(meth)acrylate, (propoxylated)_{3-60 glycerol tri(meth)acrylate, (ethoxylated)}₃₋₆₀ trimethylolpropane tri(meth)acrylate, (propoxylated)₃₋₆₀ trimethylolpropane tri(meth)acrylate, (ethoxylated)₃₋₆₀ isocyanurate tri(meth)acrylate, (propoxylated)₃₋₆₀ isocyanurate tri(meth)acrylate, (ethoxylated)₄₋₈₀ pentaerythritol tetra(meth)acrylate, (propoxylated)₄₋₈₀ pentaerythritol tetra(meth)acrylate, (ethoxylated)₆₋₁₂₀ dipentaerythritol tetra(meth)acrylate, (propoxylated)₆₋₁₂₀ dipentaerythritol tetra(meth)acrylate, and the like, and mixtures thereof.

Many additional suitable acryloyl monomers are described in U.S. Pat. No. 6,627,704 B2 to Yeager et al.

The olefinically unsaturated monomer may comprise an alkenyl aromatic monomer. The alkenyl aromatic monomer may have the formula 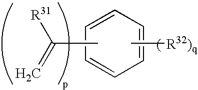
wherein each occurrence of R³¹ is independently hydrogen or C₁-C₁₈ hydrocarbyl; each occurrence of R³² is independently halogen, C₁-C₁₂ alkyl, C₁-C₁₂ alkoxyl, or C₆-C₁₈ aryl; p is 1 to 4; and q is 0 to 5. Suitable alkenyl aromatic monomers include, for example, styrene, α-methylstyrene, 2-methylstyrene, 3-methylstyrene, 4-methylstyrene, vinyl toluene, 2-t-butylstyrene, 3-t-butylstyrene, 4-t-butylstyrene, 1,3-divinylbenzene, 1,4-divinylbenzene, 1,3-diisopropenylbenzene, 1,4-diisopropenylbenzene, styrenes having from 1 to 5 halogen substituents on the aromatic ring, and the like, and combinations thereof. Preferred alkenyl aromatic monomers include styrene, vinyl toluene, and 4-t-butylstyrene.

In one embodiment, the olefinically unsaturated monomer comprises an alkenyl aromatic monomer and an acryloyl monomer comprising at least two acryloyl moieties.

The olefinically unsaturated monomer may comprise an allylic monomer. An allylic monomer is an organic compound comprising at least one, preferably at least two, more preferably at least three allyl(—CH₂—CH═CH₂) groups. Suitable allylic monomers include, for example, diallyl phthalate, diallyl isophthalate, triallyl mellitate, triallyl mesate, triallyl benzenes, triallyl cyanurate, triallyl isocyanurate, mixtures thereof, partial polymerization products prepared therefrom, and the like.

The olefinically unsaturated monomer may comprise a vinyl ether. Vinyl ethers are compounds comprising at least one moiety having the structure
H₂C═CH—O—*
Suitable vinyl ethers include, for example, 1,2-ethylene glycol divinyl ether, 1,3-propanediol divinyl ether, 1,4-butanediol divinyl ether, triethyleneglycol divinyl ether, 1,4-cyclohexanedimethanol divinyl ether, ethyl vinyl ether, n-butyl vinyl ether, lauryl vinyl ether, 2-chloroethyl vinyl ether, and the like, and mixtures thereof.

The olefinically unsaturated monomer may comprise a maleimide. A maleimide is a compound comprising at least one moiety having the structure 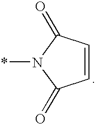
Suitable maleimides include, for example, N-phenylmaleimide, 1,4-phenylene-bis-methylene-α,α′-bismaleimide, 2,2-bis(4-phenoxyphenyl)-N,N′-bismaleimide, N,N′-phenylene bismaleimide, N,N′-hexamethylene bismaleimide, N—N′-diphenyl methane bismaleimide, N,N′-oxy-di-p-phenylene bismaleimide, N,N′-4,4′-benzophenone bismaleimide, N,N′-p-diphenylsulfone bismaleimide, N,N′-(3,3′-dimethyl)methylene-di-p-phenylene bismaleimide, poly(phenylmethylene) polymaleimide, bis(4-phenoxyphenyl)sulfone-N,N′-bismaleimide, 1,4-bis(4-phenoxy)benzene-N,N′-bismaleimide, 1,3-bis(4-phenoxy)benzene-N,N′-bismaleimide, 1,3-bis(3-phenoxy)benzene-N,N′-bismaleimide, and the like, and mixtures thereof.

The curable compound may comprise an unsaturated polyester resin. An unsaturated polyester is generally obtained by reaction of at least one polyhydric alcohol with at least one polybasic acid comprising an unsaturated polybasic acid. Specific examples of unsaturated polybasic acids that may be used to form the unsaturated polyester include maleic anhydride, maleic acid, fumaric acid, itaconic acid, citraconic acid, chloromaleic acid, dimeric methacrylic acid, nadic acid, tetrahydrophthalic acid, endo-methylenetetrahydrophthalic acid, hexachloro-endo-methylenetetrahydrophthalic acid, halogenated phthalic acids, and the like, as well as their corresponding acids, esters, and anhydrides. Preferred unsaturated acids include maleic acid, fumaric acid, and their esters and anhydrides.

Often, polyfunctional saturated and aromatic acids are employed in conjunction with the polybasic unsaturated acids to reduce the density of the ethylenic unsaturation and provide the desired chemical and mechanical properties to the coating. Examples of saturated and aromatic polybasic acids include succinic acid, adipic acid, sebacic acid, azelaic acid, dodecanedioic acid, eicoic acid, phthalic acid, isophthalic acid, terephthalic acid, and the like, as well as their esters and anhydrides. Preferred aromatic polybasic acids include phthalic acid, isophthalic acid, and their esters and anhydrides.

Examples of polyhydric alcohols include ethylene glycol, propylene glycol, diethylene glycol, dipropylene glycol, 1,2-butanediol, 1,3-butanediol, 1,4-butanediol, neopentyl glycol, glycerol, triethylene glycol, pentanediol, hexylene glycol, hydrogenated bisphenol A, bisphenol A-alkylene oxide adducts, tetrabromobisphenol A-alkylene oxide adducts, and the like. Preferred polyhydric alcohols include propylene glycol.

Unsaturated polyesters are commercially available, often as compositions further comprising an alkenyl aromatic monomer, and include, for example, the unsaturated polyester resins obtained from Ashland as Ashland Q6585, and from Alpha Owens Corning as AOC-XV2346.

In one embodiment, the curable compound comprises an unsaturated polyester resin in combination with a curable compound selected from styrene, t-butyl styrene, alpha-methyl styrene, para-methyl styrene, vinyl toluene, divinyl benzene, diallyl phthalate, diallyl isophthalate, diallyl maleate, triallyl isocyanurate, triallyl cyanurate, dibutyl maleate, dicyclopentyloxyethyl methacrylate, meta-diisopropenylbenzene, and combinations thereof.

The curable compound may comprise an epoxy resin. Suitable classes of epoxy resins include, for example, aliphatic epoxy resins, cycloaliphatic epoxy resins, bisphenol-A epoxy resins, bisphenol-F epoxy resins, phenol novolac epoxy resins, cresol-novolac epoxy resins, biphenyl epoxy resins, 3,3′,5,5′-tetra-methyl biphenol epoxy resins (EPIKOTE XY4000), polyfunctional epoxy resins (i.e., epoxy resins comprising at least three epoxy groups), naphthalene epoxy resins (e.g., EPICLON® EXA-4700 from Dainippon Ink and Chemicals), divinylbenzene dioxide, 2-glycidylphenylglycidyl ether, dicyclopentadiene-type (DCPD-type) epoxy resins (e.g., EPICLON® HP-7200 from Dainippon Ink and Chemicals), multi aromatic resin type (MAR-type) epoxy resins, and the like, and combinations thereof. All of these classes of epoxy resins are known in the art and are both widely commercially available and preparable by known methods. Specific suitable epoxy resins are described, for example, in U.S. Pat. No. 4,882,201 to Crivello et al., U.S. Pat. No. 4,920,164 to Sasaki et al., U.S. Pat. No. 5,015,675 to Walles et al., U.S. Pat. No. 5,290,883 to Hosokawa et al., U.S. Pat. No. 6,333,064 to Gan, U.S. Pat. No. 6,518,362 to Clough et al, U.S. Pat. No. 6,632,892 to Rubinsztajn et al., U.S. Pat. No. 6,800,373 to Gorczyca, U.S. Pat. No. 6,878,632 to Yeager et al.; U.S. Patent Application Publication No. 2004/0166241 to Gallo et al., and WO 03/072628 A1 to Ikezawa et al. In one embodiment, the epoxy resin has a softening point of about 25° C. to about 150° C. Within this range, the melting point may be at least about 30° C. or at least about 35° C. Also within this range, the melting point may be up to about 100° C. or up to about 50° C. Softening points may be determined according to ASTM E28-99 (2004).

The curing agent (B) generally used for epoxy resins may be, for example a bifunctional or higher functional compound having functional groups such as amino, acid anhydride, hydroxyl, carboxyl, and mercapto groups. Examples are amines, acid anhydrides, and phenolic resins. In particular novolac-type phenolic resins are preferred. Their structures and molecular weights are not particularly limited so long as they contain at least two hydroxyl groups per molecule. Specific examples of novolac-type phenolic resins are phenol novolac, bisphenol A novolac, cresol novolac, and xylenol novolac.

The curing promoter (C) used in the epoxy resins may include, for example, imidazoles, organic phosphines, phosphonium salts, amines, cycloamidines, and metal acetylacetonates. Specific examples include 2-methylimidazole, 2-ethyl-4-methylimidazole, 2-phenylimidazole, dicyanodiamide, and aluminum acetylacetonate.

The curable compound may comprise a polyester/epoxy copolymer resin. Polyester/epoxy copolymer resins comprise both ester and epoxy functionality. Representative polyester/epoxy copolymer resins include those described in U.S. Pat. No. 6,127,490 to Fazio. In this reference, the polyester/epoxy copolymer resin is prepared by first reacting maleic acid with dicyclopentadiene to produce a ten-carbon double ring ester, promoting esterification by the addition of a hydroxyl-containing compound such as an alcohol or glycol, and then reacting the resulting intermediate with a polyfunctional epoxy compound such as bisphenol A diglycidyl ether. Other suitable polyester/epoxy copolymer resins are described, for example, in U.S. Pat. No. 4,703,338 to Sagami et al. Combinations of polyester/epoxy resins with alkenyl aromatic compounds such as styrene or vinyl toluene may be used.

The curable compound may comprise an unsaturated esterimide resin. In general the preparation of polyesterimides involves polycondensation between an aromatic carboxylic anhydride containing at least one additional carboxylic group and at least one alpha,beta-ethylenically unsaturated dicarboxylic acid with a diamine and a diol and/or ethanolamine. The resultant compound contains a five-membered cyclic imide ring and alpha,beta-ethylenically unsaturated dicarboxylic acid ester. The preparation of polyesterimides is described, for example, in U.S. Pat. No. 4,273,917 to Zamek, and “Synthesis and Characterization of Novel Polyesterimides” J.-Y. Shieh, P.-H. Hsu, C.-S. Wang, J. Applied Polym. Sci., Vol. 94, pages 730-738 (2004). Thermosetting unsaturated polyesterimides are commercially available in vinyl toluene or styrene, such as, for example, von-Roll Isola's Damisol 3309 and Altana Chemie's Dobeckan 2025).

The curable compound may comprise a curable silicone resin. Curable silicone resins are polysiloxanes comprising polymerizable functionality. For example, a curable silicone may comprise a polydialkylsiloxane with terminal silyl hydride functionality and a polydialkylsiloxane with terminal vinyl silane functionality that enables polymerization via a catalyzed hydrosilylation reaction. Such compositions are described, for example, in U.S. Pat. Nos. 4,029,629 and 4,041,010 to Jeram, U.S. Pat. No. 4,061,609 to Bobear, and U.S. Pat. No. 4,329,273 to Hardman et al.

The curable composition may comprise about 50 to about 99 weight percent of the curable compound, based on the total weight of the curable composition. Within this range, the curable compound amount may be at least about 60 weight percent, or at least about 70 weight percent. Also within this range, the curable compound amount may be up to about 95 weight percent, or up to about 90 weight percent.

The curable composition may, optionally, further comprise a cure catalyst. Selection of a cure catalyst type and amount will depend on factors including the type of curable functionality present on the functionalized poly(arylene ether), the type of curable functionality present on the curable compound, and the application technique employed. For example, when the functionalized poly(arylene ether) contains polymerizable carbon-carbon double bond functionality and the curable compound comprises an olefinically unsaturated monomer or an unsaturated polyester resin, the cure catalyst may comprise peroxy cure catalysts (such as, for example, benzoyl peroxide, dicumyl peroxide, methyl ethyl ketone peroxide, lauryl peroxide, cyclohexanone peroxide, t-butyl hydroperoxide, t-butyl benzene hydroperoxide, t-butyl peroctoate, 2,5-dimethylhexane-2,5-dihydroperoxide, 2,5-dimethyl-2,5-di(t-butylperoxy)-hex-3-yne, di-t-butylperoxide, t-butylcumyl peroxide, α,α′-bis(t-butylperoxy-m-isopropyl)benzene, 2,5-dimethyl-2,5-di(t-butylperoxy)hexane, di(t-butylperoxy) isophthalate, t-butylperoxy benzoate, 2,2-bis(t-butylperoxy)butane, 2,2-bis(t-butylperoxy)octane, 2,5-dimethyl-2,5-di(benzoylperoxy)hexane, di(trimethylsilyl)peroxide, trimethylsilylphenyltriphenylsilyl peroxide, and the like, and mixtures thereof), or non-peroxy based radical initiators (such as, for example, 2,3-dimethyl-2,3-diphenylbutane, 2,3-bis(trimethylsilyloxy)-2,3-diphenylbutane, and the like, and mixtures thereof), and anionic polymerization initiators (such as, for example, alkali metal amides, such as sodium amide (NaNH₂) and lithium diethyl amide (LiN(C₂H₅)₂); alkali metal and ammonium salts of C₁-C₁₀ alkoxides; alkali metal and ammonium hydroxides; alkali metal cyanides; organometallic compounds such as the alkyl lithium compound n-butyl lithium; Grignard reagents such as phenyl magnesium bromide; and the like; and combinations thereof). Other suitable cure catalysts for olefinically unsaturated monomer compositions include those described in U.S. Pat. No. 5,407,972 to Smith et al., and U.S. Pat. No. 5,218,030 to Katayose et al. The peroxy catalysts in this paragraph are also effective cure agents for polyester/epoxy copolymers and unsaturated esterimide resins.

As another example, when the functionalized poly(arylene ether) contains epoxy functionality or functionality capable of reacting with epoxy groups, and the curable compound comprises an epoxy resin, the cure catalyst may comprise a latent cationic cure catalyst such as a diaryliodonium salt. Suitable latent cationic cure catalyst include those described in U.S. Pat. No. 4,623,558 to Lin, U.S. Pat. No. 4,882,201 to Crivello et al., and U.S. Pat. No. 5,064,882 to Walles et al.

As another example, when the functionalized poly(arylene ether) contains polymerizable carbon-carbon double bond functionality and the curable compound comprises a curable silicone resin comprising vinyl silane and silyl hydride functionality, the cure catalyst may comprise a platinum hydrosilylation catalyst, such as those described, for example, in U.S. Pat. Nos. 4,029,629 and 4,041,010 to Jeram, U.S. Pat. No. 4,061,609 to Bobear, and U.S. Pat. No. 4,329,273 to Hardman et al.

When present, the cure catalyst generally may be used at about 0.1 to about 5 parts by weight per 100 parts by weight total of the functionalized poly(arylene ether) and the curable compound.

The curable composition may, optionally, further comprise other additives known in the art including, for example, cure co-catalysts, cure inhibitors, mineral fillers, thixotropes, UV tracers, flame retardants, and combinations thereof.

The curable composition exhibits highly desirable physical properties after curing. For example, the composition after curing may exhibit an unnotched Izod impact strength of about 220 to about 275 joules per meter measured according to ASTM D4812. As another example, the composition after curing may exhibit a tensile strength of about 58 to about 65 megapascals measured according to ASTM D638. As another example, the composition after curing may exhibit a tensile elongation at break of about 2.5 to about 3.6 percent measured according to ASTM D638.

One embodiment is a method of insulating an electrically conductive material, comprising: applying to the electrically conductive material a curable composition comprising about 5 to about 50 weight percent of a (meth)acrylate-capped poly(arylene ether) having an intrinsic viscosity of about 0.06 to about 0.3 deciliter/gram in chloroform at 25° C.; and about 50 to about 95 weight percent of a curable compound comprising an alkenyl aromatic monomer and an acryloyl monomer comprising at least two acryloyl moieties.

Another embodiment is a method of insulating an electrically conductive material, comprising: applying to the electrically conductive material a curable composition comprising about 5 to about 40 weight percent of a (meth)acrylate-capped poly(arylene ether) having an intrinsic viscosity of about 0.06 to about 0.3 deciliter/gram in chloroform at 25° C.; and about 60 to about 95 weight percent of an unsaturated polyester resin.

The invention extends to insulating varnishes obtained on curing the curable composition described herein. Thus, one embodiment is an electrical insulation varnish, comprising the cured product of a curable composition comprising a functionalized poly(arylene ether); and a curable compound selected from olefinically unsaturated monomers, unsaturated polyester resins, epoxy resins, polyester/epoxy copolymers, unsaturated esterimide resins, curable silicones, and combinations thereof.

The invention further extends to electrical conductors insulated using the curable composition described herein. Thus, one embodiment is an insulated electrical conductor, comprising: an electrically conductive material; and an electrically insulating material contacting said electrically conductive material, said electrically insulating material comprising the reaction product of a curable composition comprising a functionalized poly(arylene ether), and a curable compound selected from olefinically unsaturated monomers, unsaturated polyester resins, epoxy resins, polyester/epoxy copolymers, unsaturated esterimide resins, curable silicones, and combinations thereof.

Alternatively, the electrically conductive material may first be coated with a protective and/or electrically insulating layer, such as a varnish or mica tape, and then subsequently coated with an electrically insulating material comprising the reaction product of a curable composition comprising a functionalized poly(arylene ether), and a curable compound selected from olefinically unsaturated monomers, unsaturated polyester resins, epoxy resins, polyester/epoxy copolymers, unsaturated esterimide resins, curable silicones, and combinations thereof.

The invention is further illustrated by the following non-limiting examples.

### EXAMPLES 1-16, COMPARATIVE EXAMPLES 1-8

Sixteen inventive examples were compared to eight commercially available resins. Examples 1-3 represent replicates of one inventive composition; Examples 4 and 5 represent replicates of another inventive composition. The inventive compositions are detailed in Table 1. All component amounts are in parts by weight (pbw). The poly(arylene ether) was a methacrylate-capped poly(2,6-dimethyl-1,4-phenylene ether) resin having an intrinsic viscosity of 0.12 deciliters per gram measured at 25° C. in chloroform. It was prepared according to the procedure described in U.S. Pat. No. 6,627,704, column 26, lines 45-54. Ethoxylated (2) bisphenol A dimethacrylate was obtained as SR348 from Sartomer Company, Inc. Inventive compositions were prepared by dissolving the poly(arylene ether) in the styrene and t-butyl catechol at 90° C. Next, the mold release and ethoxylated bisphenol A dimethacrylate were added and mixed thoroughly. Finally the 2,5-dimethyl-2,5-di(t-butylperoxy)hexane was added and mixed thoroughly. The mixture was degassed in a vacuum oven at 110° C. and 25 inches of vacuum and then poured into the mold, which was preheated to 100° C. and placed in an oven at 110° C. for 120 minutes. Then the temperature was increased to 150° C. After ten minutes at 150° C. the oven was turned off. After cooling overnight in the oven, the cured plaque was removed from the mold and cut into test specimens.

TABLE 1

| | Ex. 1 | Ex. 2 | Ex. 3 | Ex. 4 | Ex. 5 | Ex. 6 | Ex. 7 |
|---|---|---|---|---|---|---|---|
| poly(arylene ether) (pbw) | 25.00 | 25.00 | 25.00 | 25.00 | 25.00 | 20.83 | 20.83 |
| Styrene (pbw) | 50.00 | 50.00 | 50.00 | 62.50 | 62.50 | 64.58 | 58.33 |
| ethoxylated bisphenol A dimethacrylate (pbw) | 25.00 | 25.00 | 25.00 | 12.50 | 12.50 | 14.58 | 20.83 |
| 2,5-dimethyl-2,5-di(t-butylperoxy)hexane (pbw) | 1.5 | 1.5 | 1.5 | 1.5 | 1.5 | 1.5 | 1.5 |
| Mold Release, Zelec UN (pbw) | 1.0 | 1.0 | 1.0 | 1.0 | 1.0 | 1.0 | 1.0 |
| t-butyl catechol (stabilizer) (pbw) | 0.025 | 0.025 | 0.025 | 0.025 | 0.025 | 0.025 | 0.025 |

Examples 8-16 were prepared in similar manner. Compositions are detailed in Table 2.

TABLE 2

| | Ex. 8 | Ex. 9 | Ex. 10 | Ex. 11 | Ex. 12 | Ex. 13 | Ex. 14 | Ex. 15 | Ex. 16 |
|---|---|---|---|---|---|---|---|---|---|
| poly(arylene ether) (pbw) | 12.5 | 14.58 | 14.58 | 12.5 | 20.83 | 16.67 | 12.5 | 12.5 | 8.33 |
| Styrene (pbw) | 62.5 | 64.58 | 70.84 | 75 | 70.84 | 66.66 | 75 | 62.5 | 70.84 |
| ethoxylated bisphenol A dimethacrylate (pbw) | 25 | 20.84 | 14.58 | 12.5 | 8.33 | 16.67 | 12.5 | 25 | 20.83 |
| 2,5-dimethyl-2,5-di(t-butylperoxy)hexane (pbw) | 1.5 | 1.5 | 1.5 | 1.5 | 1.5 | 1.5 | 1.5 | 1.5 | 1.5 |
| Mold Release Zelec UN (pbw) | 1 | 1 | 1 | 1 | 1 | 1 | 1 | 1 | 1 |
| t-butyl catechol (stabilizer) (pbw) | 0.025 | 0.025 | 0.025 | 0.025 | 0.025 | 0.025 | 0.025 | 0.025 | 0.025 |

Comparative Example 1 used an epoxy resin composition from U.S. Pat. No. 5,618,891 of Markovitz and U.S. Pat. No. 5,314,984 of Markovitz et al. The composition consisted of 62.3 pbw DEN 429 epoxy novolac resin from Dow Chemical Company, 26.6 pbw Epon 826 bisphenol A digylcidyl ether from Resolution Performance Products, 11.1 pbw GP 5300 bisphenol A-formaldehyde novolac resin from Georgia-Pacific Resins, 1.9 pbw Zelec UN internal mold release from Stepan Company, and 0.22 pbw aluminum acetylacetonate as a catalyst from Sigma-Aldrich Fine Chemicals. The components except the catalyst were mixed together and heated to 100° C. to facilitate mixing and lower the viscosity. After the mixture became homogeneous, the catalyst was added and mixed well. The mixture was degassed in a vacuum oven, then poured into a mold and placed in an oven at 165° C. for eight hours. The heat was then turned off and the mold was allowed to cool to room temperature overnight. When formulating resins for electrical testing the internal mold release was left out of the formulation. The cured plaques were cut into test specimens.

The resins used in Comparative Examples 2-6 were as follows. Comparative Example 2 used a precatalyzed unsaturated polyester resin in 31 weight percent vinyl toluene containing 1 weight percent dicumyl peroxide obtained as 707C from Von-Roll Isola Ltd. Comparative Example 3 used an epoxy-based methacrylate vinyl ester resin in 40 weight percent styrene obtained as DERAKANE® 780 from Dow Chemical. Comparative Examples 4 was a general purpose unsaturated polyester in 31 weight percent vinyl toluene obtained as MR14072 from Ashland Chemical. Comparative Example 5 was a general purpose unsaturated polyester prepared from 1:1 mixture of maleic anhydride and propylene glycol in 34 weight percent styrene obtained as Q6585 from Ashland Chemical. Comparative Examples 6 was an isophthalic unsaturated polyester in 35 weight percent styrene obtained as T766 from AOC Resins.

The formulations for Comparative Examples 2-6 are given in Table 3.

TABLE 3

| | C. Ex. 2 | C. Ex. 3 | C. Ex. 4 | C. Ex. 5 | C. Ex. 6 |
|---|---|---|---|---|---|
| 707C (pbw) | 95 | — | — | — | — |
| Derakane 780 | — | 100 | — | — | — |
| (pbw) | | | | | |
| MR14072 (pbw) | — | — | 95 | — | — |
| Q6585 (pbw) | — | — | — | 95 | — |
| T766 (pbw) | — | — | — | — | 95 |
| Vinyl toluene | 5 | — | 5 | — | — |
| (pbw) | | | | | |
| Styrene (pbw) | — | — | — | 5 | 5 |
| Zelec UN Mold | 0.94 | 0.94 | 0.94 | 0.94 | 0.94 |
| release (pbw) | | | | | |
| t-Butyl | | 1.42 | 1.42 | 1.42 | 1.42 |
| hydroperoxide | | | | | |
| (pbw) | | | | | |

The resins and styrene or vinyl toluene were warmed to 50° C. in order to lower their viscosity. After the mixture was homogeneous the mold release and peroxide were added and mixed well. The mixture was degassed under vacuum and then poured into a mold. The mold was placed in an oven at 85° C. After sixteen hours the temperature was increased to 120° C. for six hours. The oven was then turned off and allowed to cool to room temperature overnight. When formulating resins for electrical testing the internal mold release was left out of the formulation. The cured plaques were cut into test specimens.

Formulations for Comparative Samples 7 and 8 are given in Table 4.

TABLE 4

| | C. Ex. 7 | C. Ex. 8 |
|---|---|---|
| Styrene (pbw) | 75 | 75 |
| Ethoxylated bisphenol A dimethacrylate (pbw) | 25 | 25 |
| 2,5-Dimethyl-2,5-di(t-butylperoxy)hexane (pbw) | 1.5 | 1.5 |
| Mold Release Zelec UN (pbw) | 1 | 1 |
| t-Butyl catechol (stabilizer) (pbw) | 0.025 | 0.025 |

Flexural modulus and flexural strength values, both measured in units of pounds per square inch (psi) and expressed here in units of megapascals (MPa), were determined according to ASTM D790. Notched Izod impact strength values, measured in units of foot-pounds per inch and expressed her in units of joules per meter (J/m), were determined according to ASTM D256. Unnotched Izod impact strength values, measured in units of foot-pounds per inch and expressed here in units of joules per meter, were determined according to ASTM D4812. Heat distortion temperatures, measured at 264 psi (1.82 MPa) in units of degrees Fahrenheit and expressed here in units of degrees Celsius, were determined according to ASTM D648.

Shrinkage was measured after samples had been cured. Measurements were performed at ambient temperatures. The width of the mold was measured at the bottom, middle, and top. The width of the cured material was measured at the bottom, middle, and top. The percent shrinkage was calculated using the following equation:

$$\% Shrinkage = \frac{( Width mold - width sample )}{Width mold} \times 100$$

The % shrinkage reported is the average value from the shrinkage at the bottom, middle and top.

Tensile strength and tensile modulus (also referred to as modulus of elasticity), both measured in units of pounds per square inch (psi) and expressed here in units of megapascals (MPa), were determined according to ASTM D638. Tensile elongation at break, expressed in units of percent, was also determined according to ASTM D638 for 0.3175 centimeter (⅛ inch) thick test specimens and tensile bars 17.78 centimeters (7 inches) in length.

Moisture uptake was measured on 6.35 centimeter×1.27 centimeter x 0.3175 centimeter (2½ inch×½ inch×⅛ inch) parts. The test parts were dried overnight in a vacuum oven at 120° C. for eight hours. The dried test parts were immersed in water at ambient temperatures for fifteen days. The samples were then removed from the water, their surface water was wiped off, and they were weighed. Weight increase was calculated from the weights of the dry and immersed samples and reported as % increase in weight.

Dielectric constant values under wet and dry conditions were determined according to IPC650 and measured at 1 megahertz (MHz) frequency. Dissipation factor values under wet and dry conditions were also determined according to IPC650 and measured at 1 MHz frequency. For measurement of dielectric constants and dissipation factors under “wet” conditions, samples were immersed in deionized water for 24 hours at 23° C. For measurement under “dry” conditions, samples were prepared by drying the samples in a 120° C. oven for at least four hours and then storing it in a desiccator to cool it down to room temp. After drying, the samples were then conditioned at 23° C. and 50% relative humidity for 24 hours before testing.

Weight losses after 720 hours at 180, 200, and 220° C., expressed in values of weight percent, were determined by drying the samples in a 120° C. oven for at least four hours and recording the initial weight. Then the samples were heat aged in an air circulating oven for 720 hours at the appropriate temperature. After heat aging the sample weight was measured and recorded as the final weight. The percent weight loss during heat aging was calculated using the following equation:

$$\% weight loss = \frac{( Initial weight - Final weight )}{Initial weight} \times 100$$

Property values are presented in Table 5. The data show that, relative to the commercial resins, the inventive compositions exhibit increased flexural strength, increased impact strength (notched and unnotched Izod values), increased tensile strength, increased elongation at break, and decreased moisture uptake.

TABLE 5

| | Ex. 1 | Ex. 2 | Ex. 3 | Ex. 4 | Ex. 5 | Ex. 6 | Ex. 7 |
|---|---|---|---|---|---|---|---|
| flexural modulus (MPa) | 3056 | 2049.4 | 3054.1 | 3060.2 | 2982.5 | 3045.5 | 3057.6 |
| flexural strength (MPa) | 122.0 | 115.9 | 121.2 | 116.6 | 111.5 | 118.4 | 120.3 |
| unnotched Izod (J/m) | 226.2 | 223.5 | 234.2 | 272.09 | 264.1 | 245.8 | 226.7 |
| notched Izod (J/m) | 25.6 | 25.6 | 26.1 | 26.1 | 25.6 | 24.0 | 23.5 |
| heat distortion temperature | 118.4 | 124.5 | 119.03 | 109.5 | 109.6 | 94.9 | 113.4 |
| at 1.82 MPa (° C.) | | | | | | | |
| shrinkage (%) | 1.59 | 1.76 | 1.43 | 1.53 | 1.46 | 2.01 | 2.18 |
| tensile strength (MPa) | 64.93 | 63.93 | 62.38 | 60.63 | 60.55 | 58.39 | 58.92 |
| tensile modulus (MPa) | 2897.5 | 2924.5 | 2881.4 | 2843.4 | 2832.6 | 2774.7 | 2823.4 |
| tensile elongation at break (%) | 3.5 | 3.5 | 3.6 | 2.5 | 2.5 | 2.6 | 3.1 |
| moisture uptake after 15 days | 0.306 | 0.313 | 0.316 | 0.275 | 0.281 | 0.295 | 0.312 |
| in water (wt %) | | | | | | | |
| dielectric constant, dry | 2.74 | 2.74 | 2.73 | 2.61 | 2.67 | 2.66 | 2.71 |
| dielectric constant, wet | 2.77 | 2.79 | 2.78 | 2.65 | 2.71 | 2.69 | 2.74 |
| dissipation factor, dry | 0.018 | 0.017 | 0.017 | 0.016 | 0.016 | 0.018 | 0.018 |
| dissipation factor, wet | 0.021 | 0.021 | 0.020 | 0.019 | 0.019 | 0.018 | 0.019 |
| weight loss, 180° C., | 1.40 | 1.62 | 1.70 | 2.96 | 2.91 | 3.58 | 2.43 |
| 720 hours (%) | | | | | | | |
| weight loss, 200° C., | 4.67 | 4.11 | 4.73 | 6.11 | 5.97 | 7.16 | 5.27 |
| 720 hours (%) | | | | | | | |
| weight loss, 220° C., | 6.05 | 5.49 | 6.13 | 6.70 | 7.01 | 7.97 | 7.25 |
| 720 hours (%) | | | | | | | |

| | Ex. 8 | Ex. 9 | Ex. 10 | Ex. 11 | Ex. 12 | Ex. 13 | Ex. 14 | Ex. 15 | Ex. 16 |
|---|---|---|---|---|---|---|---|---|---|
| flexural modulus (MPa) | 2894 | 2888.3 | 2875.5 | 2883.2 | 3004.3 | 2962 | 2877.9 | 2889.7 | 2770.5 |
| flexural strength (MPa) | 116.3 | 109.2 | 101.6 | 101.5 | 108.5 | 113.2 | 97 | 113.3 | 98.4 |
| unnotched Izod (J/m) | 180.5 | 178.7 | 204.9 | 205.4 | 204.9 | 196.3 | 203.8 | 181.9 | 183 |
| notched Izod (J/m) | 25.6 | 22.9 | 24 | 25.6 | 24 | 22.4 | 25.1 | 25.1 | 23.5 |
| heat distortion temperature | 93.7 | 86.9 | 91 | 81.3 | 95.2 | 95.4 | 81.2 | 95.4 | 79.3 |
| at 1.82 MPa (° C.) | | | | | | | | | |
| shrinkage (%) | 2.65 | 2.72 | 2.55 | 2.58 | 1.75 | 2.44 | 2.76 | 3.05 | 3.28 |
| tensile strength (MPa) | 54.8 | 56.2 | 57.7 | 56.9 | 55.3 | 58.1 | 54.7 | 55.6 | 56.9 |
| tensile modulus (MPa) | 2721.3 | 2754.7 | 2759.4 | 2622 | 2748.3 | 2673.3 | 2671.3 | 2741.4 | 2727.2 |
| tensile elongation at break (%) | 3.1 | 2.7 | 2.2 | 2.1 | 2.1 | 2.5 | 2.2 | 2.9 | 2.6 |
| moisture uptake after 15 days | 0.314 | 0.306 | 0.265 | 0.233 | 0.217 | 0.298 | 0.235 | 0.311 | 0.297 |
| in water, wt % | | | | | | | | | |
| dielectric constant, dry | 2.65 | 2.68 | 2.64 | 2.64 | 2.63 | 2.68 | 2.63 | 2.39 | 2.67 |
| dielectric constant, wet | 2.69 | 2.72 | 2.68 | 2.67 | 2.66 | 2.7 | 2.65 | 2.74 | 2.71 |
| dissipation factor, dry | 0.017 | 0.016 | 0.014 | 0.015 | 0.014 | 0.016 | 0.015 | 0.016 | 0.016 |
| dissipation factor, wet | 0.019 | 0.019 | 0.018 | 0.017 | 0.017 | 0.018 | 0.015 | 0.019 | 0.018 |
| weight loss, 180° C., | 4.04 | 3.73 | 5.2 | 5.6 | 4.26 | 4.12 | 5.51 | 4.09 | 5.9 |
| 720 hours (%) | | | | | | | | | |
| weight loss, 200° C., | 8.6 | 7.78 | 9.7 | 10.1 | 7.99 | 8.15 | 10.89 | 8.37 | 12.93 |
| 720 hours (%) | | | | | | | | | |
| weight loss, 220° C., | 10.7 | 10.27 | 11.25 | 11.74 | 9.3 | 9.83 | 12.25 | 10.28 | 13.3 |
| 720 hours (%) | | | | | | | | | |

| | C. Ex. 1 | C. Ex. 2 | C. Ex. 3 | C. Ex. 4 | C. Ex. 5 | C. Ex. 6 |
|---|---|---|---|---|---|---|
| flexural modulus (MPa) | 3253 | 3585 | — | 3390 | — | 3472 |
| flexural strength (MPa) | 83.36 | 76.76 | — | — | — | — |
| unnotched Izod (J/m) | 89.68 | 78.47 | 42.17 | 31.50 | 11.74 | 51.24 |
| notched Izod (J/m) | 10.14 | 22.42 | 21.89 | — | — | 16.55 |
| heat distortion temperature | 145 | 62.4 | 135 | 126.1 | 142.2 | 123.9 |
| at 1.82 MPa (° C.) | | | | | | |
| shrinkage (%) | 0.425 | 1.79 | 2.71 | 1.64 | 2.35 | 2.17 |
| tensile strength (MPa) | 27.39 | 45.09 | 24.79 | — | — | 8.26 |
| tensile modulus (MPa) | 3879 | 3779 | 4309 | — | — | 4239 |
| tensile elongation at break (%) | 0.5 | 0.8 | 0.4 | — | — | 0.4 |
| moisture uptake after 15 days | 0.78 | 0.66 | 1.06 | 1.88 | 2.29 | 1.20 |
| in water (wt %) | | | | | | |
| dielectric constant, dry | 3.63 | 2.98 | — | — | — | — |
| dielectric constant, wet | 3.70 | 3.03 | | | | |
| dissipation factor, dry | 0.026 | 0.029 | | | | |
| dissipation factor, wet | 0.027 | 0.030 | | | | |
| weightless, 180° C., | 0.11 | 1.90 | 1.48 | — | 4.28 | 2.10 |
| 720 hours (%) | | | | | | |
| weight loss, 200° C., | 1.46 | 4.82 | 5.37 | — | 25.51 | 16.89 |
| 720 hours (%) | | | | | | |
| weight loss, 220° C., | 3.06 | 7.44 | 9.40 | — | 46.56 | 31.07 |
| 720 hours (%) | | | | | | |

| | C. Ex. 7 | C. Ex. 8 |
|---|---|---|
| flexural modulus (MPa) | 2672 | 2722.9 |
| flexural strength (MPa) | 93.79 | 91.1 |
| unnotched Izod (J/m) | 176.1 | 170.7 |
| notched Izod (J/m) | 22.4 | 22.9 |
| heat distortion temperature | 68.2 | 67.1 |
| at 1.82 MPa (□C.) | | |
| shrinkage (%) | 3.53 | 3.28 |
| tensile strength (MPa) | 55 | 54.2 |
| tensile modulus (MPa) | 2556.7 | 2551.3 |
| tensile elongation at break (%) | 2.3 | 2.4 |
| moisture uptake after 15 days | 0.275 | 0.282 |
| in water, wt % | | |
| dielectric constant, dry | — | — |
| dielectric constant, wet | — | — |
| dissipation factor, dry | — | — |
| dissipation factor, wet | — | — |
| weight loss, 180° C., | 6.8 | 7 |
| 720 hours (%) | | |
| weight loss, 200° C., | 15 | 14 |
| 720 hours (%) | | |
| weight loss, 220° C., | 16.6 | 16.5 |
| 720 hours (%) | | |

### EXAMPLES 17-21

Examples 17-21 are inventive compositions using t-butyl styrene and were prepared by dissolving the poly(arylene ether) in the t-butyl styrene and t-butyl catechol at 150° C. After the poly(arylene ether) was dissolved the temperature was decreased to 90° C. Next the mold release and ethoxylated bisphenol A dimethacrylate were added and mixed thoroughly. Finally the 2,5-dimethyl-2,5-di(t-butylperoxy)hexane as added and mixed thoroughly. The mixture was degassed in a vacuum oven at 110° C. and 25 inches of vacuum and then poured into the mold, which was preheated to 100° C. and placed in an oven at 110° C. for 120 minutes. Then the temperature was increased to 150° C. After 10 minutes at 150° C. the oven was turned off. After cooling overnight in the oven, the cured plaque was removed from the mold and cut into test specimens. Formulations for Examples 17-22 are given in Table 6.

TABLE 6

| | Ex. 17 | Ex. 18 | Ex. 19 | Ex. 20 | Ex. 21 | Ex. 22 |
|---|---|---|---|---|---|---|
| poly(arylene ether) (pbw) | 25.00 | 20.83 | 20.83 | 25.00 | 20.83 | 30.00 |
| tertiary-butyl Styrene (pbw) | 62.50 | 64.58 | 58.33 | 50.00 | 54.17 | 49.17 |
| ethoxylated bisphenol A | 12.50 | 14.58 | 20.83 | 25.00 | 25.00 | 20.84 |
| dimethacrylate (pbw) | | | | | | |
| 2,5-dimethyl-2,5-di(t- | 1.00 | 1.00 | 1.00 | 1.00 | 1.00 | 1.00 |
| butylperoxy)hexane (pbw) | | | | | | |
| Mold Release Zelec UN (pbw) | 1.00 | 1.00 | 1.00 | 1.00 | 1.00 | 1.00 |
| t-butyl catechol | 0.04 | 0.04 | 0.04 | 0.04 | 0.04 | 0.04 |
| (stabilizer) (pbw) | | | | | | |

Properties for Examples 17-21 are presented in Table 7. The use of t-butylstyrene instead of styrene results in higher heat distortion temperature at 1.82 MPa.

TABLE 7

| | Ex. 17 | Ex. 18 | Ex. 19 | Ex. 20 | Ex. 21 | Ex. 22 |
|---|---|---|---|---|---|---|
| flexural modulus (MPa) | 2630 | 2580 | 2630 | 2670 | 2690 | 2740 |
| flexural strength (MPa) | 69.4 | 72.8 | 69.2 | 69.2 | 76.1 | 70 |
| unnotched Izod (J/m) | 83.4 | 126.2 | 103.2 | 108.6 | 87.7 | 114.8 |
| notched Izod (J/m) | 12.4 | 12.0 | 11.4 | 11.4 | 11.1 | 12.1 |
| heat distortion temperature | 123 | 133 | 143 | 146 | 144 | 142 |
| at 1.82 MPa (° C.) | | | | | | |
| Density (g/cc) | 1.013 | 1.011 | 1.011 | 1.04 | 1.036 | 1.043 |

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

All ranges disclosed herein are inclusive of the endpoints, and the endpoints are combinable with each other.

All cited patents, patent applications, and other references are incorporated herein by reference in their entirety.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another.

1. A method of insulating an electrically conductive material, comprising:
applying to the electrically conductive material a curable composition comprising
a functionalized poly(arylene ether); and
a curable compound selected from olefinically unsaturated monomers, unsaturated polyester resins, epoxy resins, polyester/epoxy copolymers, unsaturated esterimide resins, curable silicones, and combinations thereof.

2. The method of claim 1, wherein said applying comprises using an application technique selected from dip and bake, dip and spin, vacuum/pressure impregnation, roll through, trickle application, and total encapsulation.

3. The method of claim 1, wherein the functionalized poly(arylene ether) comprises a capped poly(arylene ether) having the formula
Q(J-K)_{y}
wherein Q is the residuum of a monohydric, dihydric, or polyhydric phenol; y is 1 to 100; J has the formula 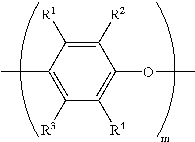
wherein R¹ and R³ are each independently selected from the group consisting of hydrogen, halogen, primary or secondary C₁-C₁₂ alkyl, C₂-C₁₂ alkenyl, C2-C₁₂ alkynyl, C₁-C₁₂ aminoalkyl, C₁-C₁₂ hydroxyalkyl, phenyl, C₁-C₁₂ haloalkyl, C₁-C₁₂ hydrocarbyloxy, and C₂-C₁₂ halohydrocarbyloxy wherein at least two carbon atoms separate the halogen and oxygen atoms; R² and R⁴ are each independently selected from the group consisting of halogen, primary or secondary C₁-C₁₂ alkyl, C₂-C₁₂ alkenyl, C2-C₁₂ alkynyl, C₁-C₁₂ aminoalkyl, C₁-C₁₂ hydroxyalkyl, phenyl, C₁-C₁₂ haloalkyl, C₁-C₁₂ hydrocarbyloxy, and C₂-C₁₂ halohydrocarbyloxy wherein at least two carbon atoms separate the halogen and oxygen atoms; m is 1 to about 200; and K is a capping group selected from the group consisting of 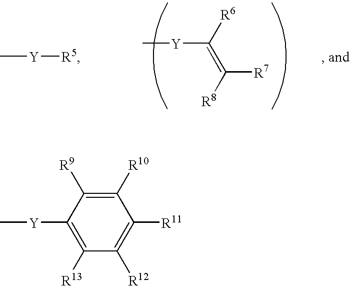
wherein R⁵ is C₁-C₁₂ hydrocarbyl optionally substituted with one or two carboxylic acid groups, R⁶-R⁸ are each independently hydrogen, C₁-C₁₈ hydrocarbyl optionally substituted with one or two carboxylic acid groups, C₂-C₁₈ hydrocarbyloxycarbonyl, nitrile, formyl, carboxylic acid, imidate, and thiocarboxylic acid; R⁹-R¹³ are each independently selected from the group consisting of hydrogen, halogen, C₁-C₁₂ alkyl, hydroxy, carboxylic acid, and amino; and wherein Y is a divalent group selected from the group consisting of 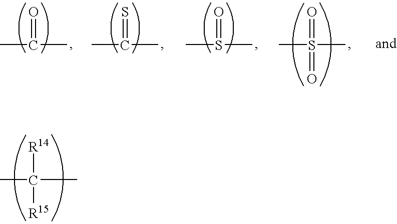
wherein R¹⁴ and R¹⁵ are each independently selected from the group consisting of hydrogen and C₁-C₁₂ alkyl.

4. The method of claim 1, wherein the functionalized poly(arylene ether) comprises a dicapped poly(arylene ether) having the structure 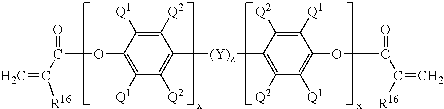
wherein each occurrence of Q² is independently selected from hydrogen, halogen, primary or secondary C₁-C₁₂ alkyl, C₂-C₁₂ alkenyl, C₃-C₁₂ alkenylalkyl, C₂-C₁₂ alkynyl, C₃-C₁₂ alkynylalkyl, C₁-C₁₂ aminoalkyl, C₁-C₁₂ hydroxyalkyl, phenyl, C₁-C₁₂ haloalkyl, C₁-C₁₂ hydrocarbyloxy, and C₂-C₁₂ halohydrocarbyloxy wherein at least two carbon atoms separate the halogen and oxygen atoms; and wherein each occurrence of Q¹ is independently selected from halogen, primary or secondary C₁-C₁₂ alkyl, C₂-C₁₂ alkenyl, C₃-C₁₂ alkenylalkyl, C₂-C₁₂ alkynyl, C₃-C₁₂ alkynylalkyl, C₁-C₁₂ aminoalkyl, C₁-C₁₂ hydroxyalkyl, phenyl, C₁-C₁₂ haloalkyl, C₁-C₁₂ hydrocarbyloxy, and C₂-C₁₂ halohydrocarbyloxy wherein at least two carbon atoms separate the halogen and oxygen atoms; each occurrence of R¹⁶ is independently hydrogen or methyl; each occurrence of x is independently 1 to about 100; z is 0 or 1; and Y has a structure selected from 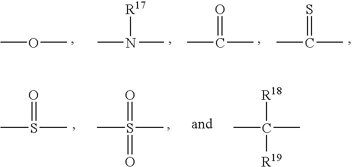
wherein each occurrence of R¹⁷, R¹⁸, and R¹⁹ is independently selected from hydrogen and C₁-C₁₂ hydrocarbyl.

5. The method of claim 1, wherein the functionalized poly(arylene ether) comprises a ring-functionalized poly(arylene ether) comprising repeating structural units of the formula 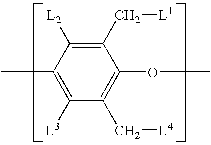
wherein each L¹-L⁴ is independently hydrogen, a C₁-C₁₂ alkyl group, an alkenyl group, or an alkynyl group; wherein the alkenyl group is represented by 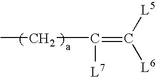
wherein L⁵-L⁷ are independently hydrogen or methyl, and a is 0, 1, 2, 3, or 4; wherein the alkynyl group is represented by 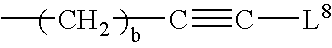
wherein L⁸ is hydrogen, methyl, or ethyl, and b is 0, 1, 2, 3, or 4; and wherein about 0.02 mole percent to about 25 mole percent of the total L¹-L⁴ substituents in the ring-functionalized poly(arylene ether) are alkenyl and/or alkynyl groups.

6. The curable composition of claim 1, wherein the functionalized poly(arylene ether) resin comprises at least one terminal functional group selected from carboxylic acid, glycidyl ether, vinyl ether, and anhydride.

7. The method of claim 1, wherein the functionalized poly(arylene ether) resin has an intrinsic viscosity of about 0.03 to about 0.6 deciliter per gram measured at 25° C. in chloroform.

8. The method of claim 1, wherein the functionalized poly(arylene ether) resin has an intrinsic viscosity of about 0.06 to about 0.3 deciliter per gram measured at 25° C. in chloroform.

9. The method of claim 1, wherein the curable composition comprises about 1 to about 50 weight percent of the functionalized poly(arylene ether), based on the total weight of the curable composition.

10. The method of claim 1, wherein the curable composition comprises an olefinically unsaturated monomer selected from acryloyl monomers, alkenyl aromatic monomers, allylic monomers, vinyl ethers, maleimides, and mixtures thereof.

11. The method of claim 1, wherein the curable compound comprises an olefinically unsaturated monomer comprising an alkenyl aromatic monomer and an acryloyl monomer comprising at least two acryloyl moieties.

12. The method of claim 1, wherein the curable compound comprises an unsaturated polyester resin.

13. The method of claim 12, wherein the curable composition further comprises a curable compound selected from styrene, vinyl toluene, t-butyl styrene, p-methyl styrene, alpha-methyl styrene, diallyl phthalate, diallyl isophthalate, diallyl maleate, triallyl isocyanurate, triallyl cyanurate, dibutyl maleate, dicyclopentyloxyethyl methacrylate, meta-diisopropenylbenzene, and combinations thereof.

14. The method of claim 1, wherein the curable compound comprises an epoxy resin.

15. The method of claim 1, wherein the curable compound comprises a polyester/epoxy copolymer.

16. The method of claim 1, wherein the curable compound comprises an unsaturated esterimide resin.

17. The method of claim 1, wherein the curable compound comprises a curable silicone resin.

18. The method of claim 1, wherein the curable composition comprises about 50 to about 99 weight percent of the curable compound, based on the total weight of the curable composition.

19. The method of claim 1, wherein the curable composition further comprises a cure catalyst.

20. The method of claim 1, wherein the curable composition further comprises an additive selected from mineral fillers, thixotropes, UV tracers, flame retardants, and combinations thereof.

21. The method of claim 1, wherein the curable composition exhibits an unnotched Izod impact strength of about 220 to about 275 joules per meter after curing.

22. The method of claim 1, wherein the curable composition exhibits a tensile strength of about 58 to about 65 megapascals after curing.

23. The method of claim 1, wherein the curable composition exhibits a tensile elongation at break of about 2.5 to about 3.6 percent after curing.

24. A method of insulating an electrically conductive material, comprising:
applying to the electrically conductive material a curable composition comprising
about 5 to about 50 weight percent of a (meth)acrylate-capped poly(arylene ether) having an intrinsic viscosity of about 0.06 to about 0.3 deciliter/gram in chloroform at 25° C.; and
about 50 to about 95 weight percent of a curable compound comprising an alkenyl aromatic monomer and an acryloyl monomer comprising at least two acryloyl moieties.

25. A method of insulating an electrically conductive material, comprising:
applying to the electrically conductive material a curable composition comprising
about 5 to about 40 weight percent of a (meth)acrylate-capped poly(arylene ether) having an intrinsic viscosity of about 0.06 to about 0.3 deciliter/gram in chloroform at 25° C.; and
about 60 to about 95 weight percent of an unsaturated polyester resin.

26. An electrical insulation varnish, comprising the cured product of a curable composition comprising
a functionalized poly(arylene ether); and
a curable compound selected from olefinically unsaturated monomers, unsaturated polyester resins, epoxy resins, polyester/epoxy copolymers, unsaturated esterimide resins, curable silicones, and combinations thereof.

27. An electrical conductor, comprising:
an electrically conductive material; and
an electrically insulating material contacting said electrically conductive material, said electrically insulating material comprising the reaction product of a curable composition comprising
a functionalized poly(arylene ether); and
a curable compound selected from olefinically unsaturated monomers, unsaturated polyester resins, epoxy resins, polyester/epoxy copolymers, unsaturated esterimide resins, curable silicones, and combinations thereof.
